(19) United States
(12) Patent Application Publication
(10) Pub. No.: US 2026/0023817 A1
(43) Pub. Date: Jan. 22, 2026

(54) APPARATUS AND METHOD FOR TRANSFORMING FLOATING-POINT DOT PRODUCT OPERATIONS INTO SIGNED INTEGER DOT PRODUCT OPERATIONS

(71) Applicant: Intel Corporation, Santa Clara, CA (US)

(72) Inventors: Chuanjun Zhang, Devon, PA (US); Mohamed Elmalaki, Chandler, AZ (US); Rafael Barbalho, Orangevale, CA (US); Andrzej Mialkowski, Folsom, CA (US); Simon C. Steely, JR., Hudson, NH (US); Matthew Adiletta, Bolton, MA (US); Michael Wibowo, San Diego, CA (US); Keith Greenan, Dublin 16 (IE)

(73) Assignee: Intel Corporation, Santa Clara, CA (US)

(21) Appl. No.: 19/341,438

(22) Filed: Sep. 26, 2025

(51) Int. Cl. G06F 17/16; G06F 9/30

(52) U.S. Cl. CPC G06F 17/16; G06F 9/30145; G06F 9/3017

(57) ABSTRACT

An apparatus and method for performing integer based FP4 dot products. One embodiment of an apparatus comprises: one or more registers to store a plurality of source 4-bit floating-point data elements; decode circuitry to decode a 4-bit floating-point dot product instruction, the instruction having an opcode to indicate one or more 4-bit floating-point dot product operations to be performed and one or more fields indicate a plurality of pairs of the source 4-bit floating-point data elements on which to perform the one or more dot product operations; and execution circuitry to execute the 4-bit floating-point dot product instruction, the execution circuitry to convert the plurality of pairs of 4-bit floating-point data elements to a corresponding plurality of pairs of integer data elements to perform the dot product.

### BACKGROUND

### Field of the Invention

This invention relates generally to the field of computer processors. More particularly, the invention relates to an apparatus and method for transforming floating-point dot product operations into signed integer dot product operations.

### Description of the Related Art

Conventionally, a 4-bit floating-point dot product design involves performing a 3-bit ×3-bit signed mantissa multiplication, performing exponent addition, determining the maximum exponent (can use a constant maximum of 4 for FP4 without bias), finding the difference between the exponents and the maximum exponent, and using shifters to align the mantissas to fixed-point integers. A final accumulator accumulates the fixed-point values, which are then converted back to floating-point values.

### BRIEF DESCRIPTION OF THE DRAWINGS

A better understanding of the present invention can be obtained from the following detailed description in conjunction with the following drawings, in which:

FIG. 1 illustrates a plurality of 4-bit floating-point (FP4) values and a corresponding plurality of INT5 values.

FIG. 2 illustrates an example of partial product generations for signed integer multiplication.

FIG. 3 illustrates an example of ensuring that the multiplier in a multiplication operation is always positive.

FIG. 4 illustrates an example of circuitry for performing an FP4 dot product, within conversion to INT5.

FIG. 5 illustrates an example of circuitry for performing an FP4 dot product using conversion to INT5.

FIG. 6 illustrates another example of circuitry for performing an FP4 dot product using conversion to INT5.

FIG. 7 illustrates a graph of normalized area and normalized power for conventional FP4 dot product operations and INT5-based FP4 dot product operations.

FIG. 8 illustrates FP4 values and corresponding INT8 values.

FIG. 9 illustrates example circuitry for performing an INT8 dot product.

FIG. 10 illustrates example circuitry for using INT8 dot product circuitry to perform FP4 dot product operations.

### DETAILED DESCRIPTION OF EMBODIMENTS

Disclosed herein are embodiments of instructions, embodiments of processors to perform the instructions, embodiments of methods performed by the processors when performing the instructions, embodiments of systems incorporating one or more processors to perform the instructions, and embodiments of programs or machine-readable mediums storing or otherwise providing the instructions. In the following description, numerous specific details are set forth (e.g., specific instruction operations, data formats, processor configurations, microarchitectural details, sequences of operations, etc.). However, embodiments may be practiced without these specific details. In other instances, well-known circuits, structures, and techniques have not been shown in detail to avoid obscuring the understanding of the description.

Current large language model (LLM) training and inference designs rely on 4-bit floating-point dot products with block scaling. The FP4-E2M1 representation of 4-bit values (such as MXFP4 defined in the OCP MX specification) uses 1 sign bit, 2 exponent bits, and 1 mantissa bit, providing a compact representation.

In some embodiments of this disclosure, 4-bit floating-point dot product operations with block scaling are converted into 5-bit integer dot product operations. The dot-product conversion may be performed in response to one or more instructions executed by a processor (e.g., a CPU, GPU, or accelerator). For example, a 4-bit dot product instruction may be executed using INT5-based dot product operations as described herein (e.g., without the need to modify the 4-bit dot product instruction). In these implementations, the choice between performing standard FP4 dot product operations and INT5-based FP4 dot product operations may be performed dynamically, at runtime (e.g., based on the execution capabilities of the processor, the current load on the floating-point and integer pipelines, and/or the current state of the processor).

These implementations reduce power consumption and minimize chip area by using the integer pipeline to process both FP4 and integer operations. Various optimizations are described below, including forcing multipliers in a product to be positive, precoding the left shift of the multiplicand, and adding the partial products horizontally across multipliers.

The techniques described herein may be implemented in various types of processor architectures, including, but not limited to, central processing units (CPUs), graphics processors (GPUs), and machine-learning accelerators. The 4-bit and 8-bit integer pipelines in these architectures can be adapted to support the FP4 dot product with minimal design modifications.

The embodiments described herein are particularly beneficial for language model (LLM) training and inferencing, as FP4 is a commonly used data format for LLM training and inference with shared block scaling methods. These embodiments leverage the advantages of integer processing, including the reduced area and power consumption compared to specialized floating-point designs, resulting in more efficient and cost-effective implementations.

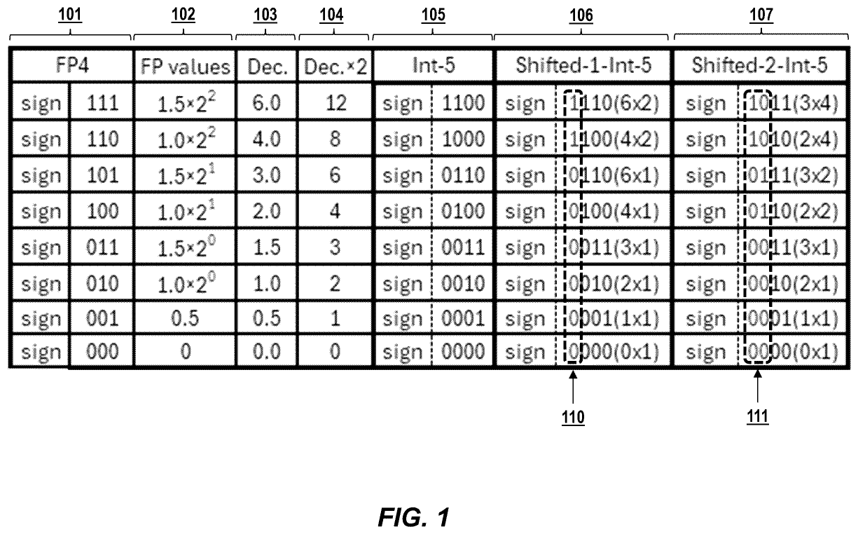

FIG. 1 illustrates a table of E2M1-FP4 values as defined by the Open Compute Project Microscaling specification (OCP Microscaling Formats (MX) Specification, ver1 (September 2023)) and the corresponding INT5 values to which the FP4 values are converted. This conversion process simplifies the handling of FP4 values by leveraging integer arithmetic, thereby enhancing computational efficiency and enabling the use of existing integer processing units for FP4 data.

The leftmost column 101 of the table presents the E2M1 format of FP4, which consists of one “sign” bit and three data bits. The data bits include a 2-bit exponent with a bias of 1 and one mantissa bit. Note that there is an implicit 1 for the mantissa, resulting in two mantissa bits for normal values.

The second column 102, “FP values,” displays the positive FP4 values in floating-point format and the third column 103 shows these values in decimal format. Among these, only two positive values are non-integers: 1.5 and 0.5. Consequently, FP4 values can be converted into integers by multiplying them by two, which transforms all values into integers, as shown in the “Dec.×2” column 104. The corresponding binary representation in integer format is displayed in the “Int-5” column 105, which illustrates the 4-bit values of the positive FP4 in integer format. In some implementations, INT5-based FP4 processing performs integer multiplications with the converted 5-bit integers (i.e., converted from FP4 values as indicated in FIG. 1).

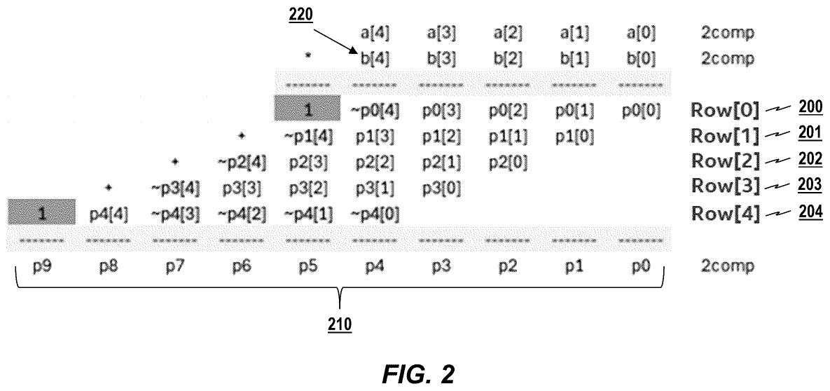

FIG. 2 illustrates an example with partial product generations for 5-bit×5-bit signed integer multiplications. In this example, a first INT5 value is represented by bits a[0]-a[4] and the second INT5 value is represented by b[0]-b[4]. There are five partial products in this example, p0-p4, each corresponding to a different row 200-204. The 1s are constants used to correct the sign and the “˜” indicates an inversion operation. The illustrated multiplication process visually represents how individual partial products, p0 to p4 in Rows[0] through [4] 100-104, respectively, are generated and then summed to produce a final result, p0 through p9 110. In particular, the final result 110 is generated through the column-wise summation of five partial product rows 200-204.

One optimization of this implementation is that the partial products can be added, instead of using multiplications as in conventional FP4 processing. As a result, a reduced number of registers are required. For example, in conventional FP4 processing, there are 16 9-bit (144-bit) registers while the summed INT5-based FP4 operations only consume 45 bits of register space.

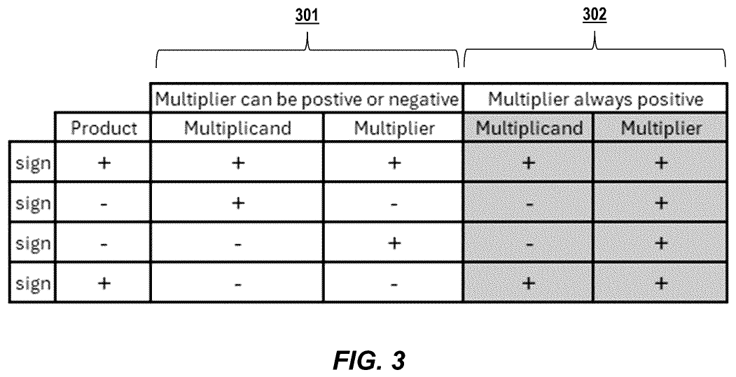

Another beneficial optimization of this implementation is that the multiplier is forced to a positive value to reduce the partial products from five to four. In a conventional multiplication, for example: Product=Multiplicand×Multiplier, there are four possible sign configurations as shown in columns 301 of FIG. 3. By changing the sign of the Multiplicand, as shown in columns 302, the sign of the Multiplier can be made positive for all operations. The benefit of enforcing the multiplier to be positive is that the bit b[4] 220 in FIG. 2 (the sign bit) is always 0 and the fifth partial product is a constant binary value of 101111, which does not need to be computed. Therefore, the partial products can be reduced from five to four.

Yet another optimization is related to precoding the left shift of the multiplicand. In column 106 in FIG. 1 (Shifted-1-Int-5), the b[3] values 110 will not be used to generate partial products, instead, the b[3] values 110 are used to left-shift the multiplicand. Consequently, muxes for left shifting can be used to replace partial product generations (AND gates) and the adder required to add the partial products. Some implementations are further optimized by left shifting two bits as shown in column 107 of FIG. 1 (Shifted-2-Int-5), where the two bits: b[4]b[3] 111, are use for left shifting with only two partial products to be generated.

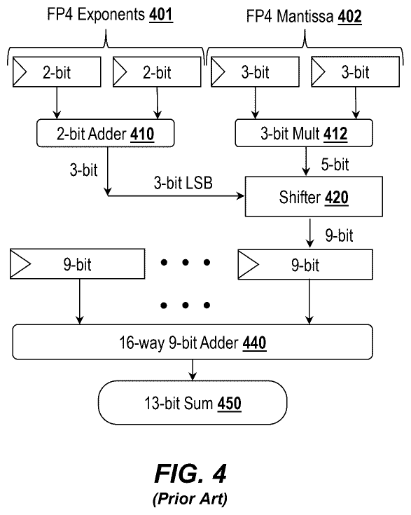

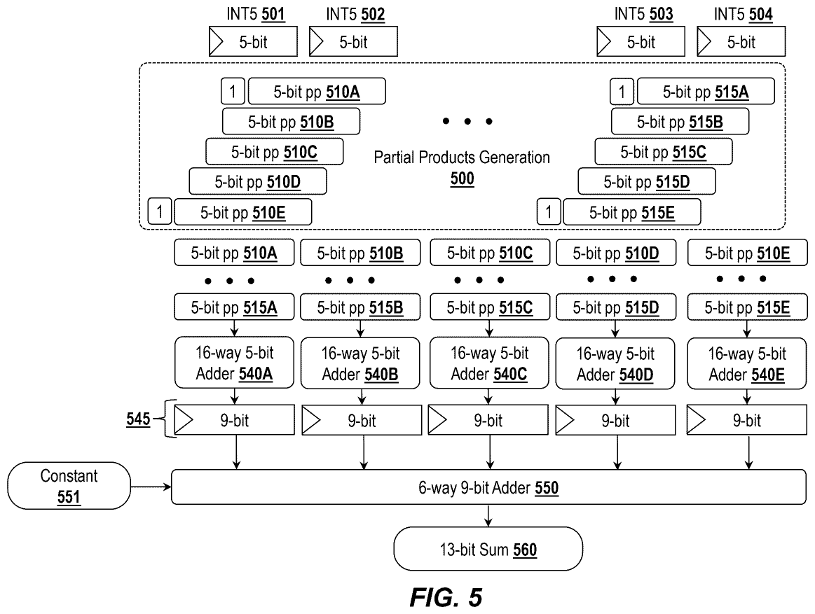

For comparison, FIG. 4 illustrates circuitry for performing an FP4 dot product without INT5 conversion and FIG. 5 illustrates example circuitry for INT5-based FP4 processing. The conventional FP4 circuitry includes a 3-bit multiplier 412 which computes the multiplication of the mantissa 402 of 3-bit in 2's complement and a 2-bit adder 410 generates a 3-bit output based on the two FP4 exponents 401. A shifter 420 left-shifts the 5-bit product generated by the mantissa multiplier 412 by the difference between the maximum exponent for FP4, which is 4 without bias, and the sum of the FP4 exponents 401. The 9-bit output of each multiplier 412 and shifter 420 is saved into register pipelines. A 16-way 9-bit adder 440 is used to compute the total sum 450 of the 16 multiplications.

In contrast, FIG. 5 illustrates an example circuit for performing the INT5-based FP4 processing with a set of source INT5 values 501-504 stored in registers. Partial products generation circuitry 500 computes the partial products 510A-E, 515A-E as shown in FIG. 2—i.e., each of the 5-bit partial products in each group 510A-E and 515A-E corresponds to one of the rows[0]-[4] 200-204 in FIG. 2. As previously described, there are five partial products in each group, the constant 1s are used to correct the sign, and the “˜” is an inversion operation. Each of a plurality of 16-way 5-bit adders 541A-E adds a corresponding group of 5-bit partial products to generate a plurality of 9-bit results stored in registers 545, which are summed with along with a constant 551 by a 6-way 9-bit adder 500 to produce a 13-bit sum 560. Thus, multiplications are not required in this implementation and the 13-bit sum 560 is generated through the use of shifting, constant values, and adding.

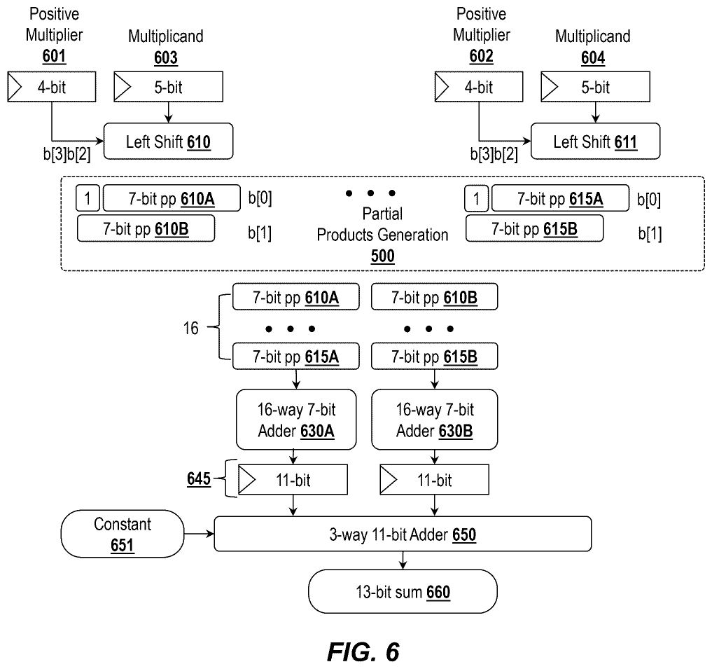

FIG. 6 illustrates another example of a circuit for performing the INT5-based FP4 processing. Each pair of FP4 input values is converted into one 4-bit always positive multiplier 601-602 and a 5-bit multiplicand 603-604, respectively (e.g., following the mapping in FIG. 1 from column 101 (FP4) to column 107 (Shifted-2-Int-5). In this implementation, when the decimal value of the FP4 value is from 0.0 to 1.5, the three least significant bits of the converted value are the same as the FP4's three least significant values. The fourth bit of the four values are a constant of zero. When the value of the FP4 value is 2.0 or 3.0, the second least significant bit of the FP4 values are inverted and the fourth bits are zero. When the value of the FP4 value is 4.0 or 6.0, one bit of zero is inserted in front of the second least significant bit of the FP4 value.

The input register space for storing each positive multiplier 601-602 and multiplicand 603-604 is reduced from 10 bits to 9 bits, as the positive indication for the multipliers 601-602 (a bit value of 0) can be dropped. The bits b[3]b[2] of each positive multiplier 601-602 are used by left shift circuits 610-611 to left-shift each respective 5-bit multiplicand 603-604 by a maximum of 2 bits to obtain 7-bit results, each of which is multiplied by each of the two bits of b[1]b[0] of the corresponding positive multiplier 601-602 to generate two corresponding 7-bit partial products 610A-B and 615A-B. While only two sets of partial products 610A-B and 615A-B are shown for simplicity, 16 such partial products may be generated in one implementation (i.e., for 16 corresponding multiplier-multiplicand pairs).

Two 16-way 7-bit adders 630A-B sum the corresponding set of 16 partial products (including partial products 610A, 615A and 610B, 615B) to generate respective 11-bit results stored in registers 645. Two corresponding 3-way 11-bit adders 645 add the 11-bit results and a precomputed constant value 651 to generate a 13-bit sum 660. Consequently, the register space for storing the intermediate results is reduced from 45 bits to 22 bits.

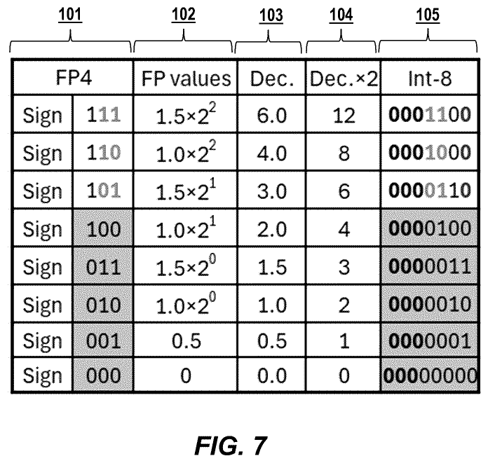

In some implementations, after converting FP4 values into INT5 values, a conventional 8-bit integer pipeline is used for execution with additional interface support. The table in FIG. 7 shows the conversion of FP4 binary values in column 101 into 8-bit signed integer values in column 105, along with the corresponding FP values 102, decimal values 103, and decimal×2 values 104.

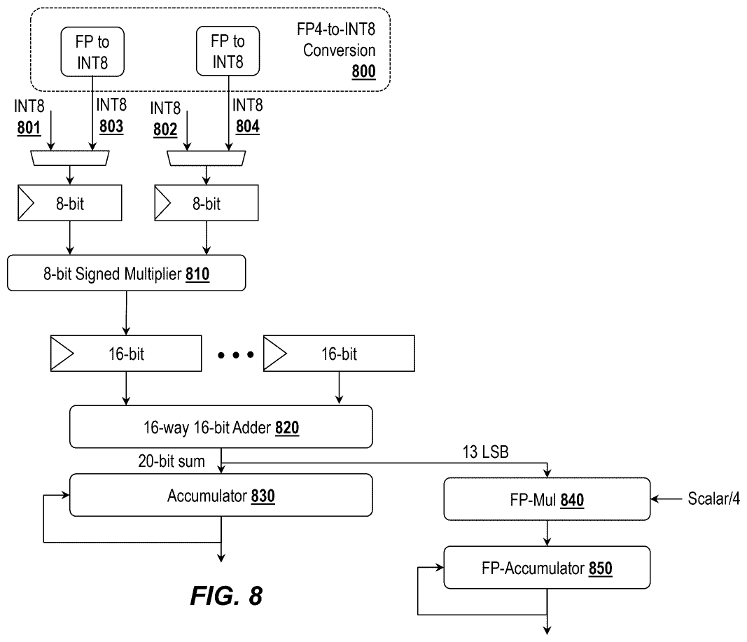

FIG. 8 illustrates an 8-bit integer dot product engine that computes 16 int-8 multiplications and additions, which is also used for performing FP4 dot product operations. By adding the FP4-to-INT8 conversion logic 800, this conventional INT8 circuitry can support both standard 8-bit integer dot products and block-scaled FP4 dot products. Input multiplexers select between standard INT8 inputs 801-802 or INT8 data elements derived from FP4 values 803-804. An 8-bit signed multiplier 810 multiplies the source INT8 values 803-804 and the resulting 16-bit products are added by a 16-=way 16-bit adder 820 to generate a 20-bit sum. For standard INT8 processing, the 20-bit sum is accumulated to an existing value in an accumulator 830. For block-scaled FP4 converted INT8 values, the 13 least significant bits of the 20-bit sum are fed into a floating point multiplier 840 to be multiplied by predetermined scalar values and the results accumulated into a floating-point (FP) accumulator 850.

This implementation allows the same 8-bit integer engine to be shared for conventional INT8 and FP4 processing, significantly reducing the required on-chip area. While this embodiment may not provide the lowest power compared to the INT5 based implementations, it provides an alternative option for area-constrained designs.

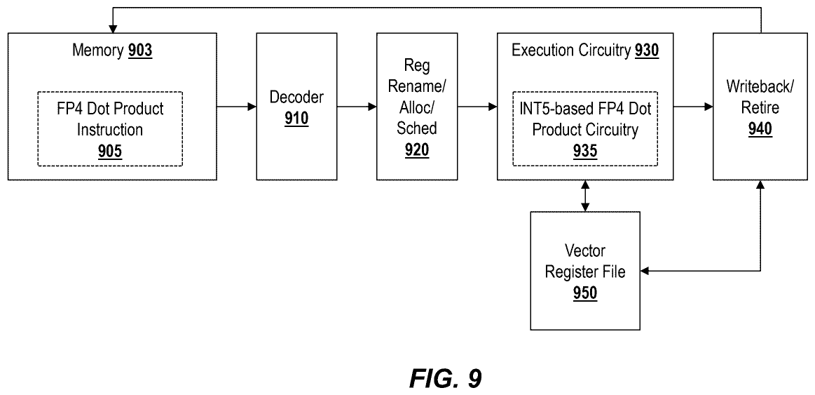

FIG. 9 is a block diagram of an embodiment of a processor or a core of a processor 900 (e.g., core 1190) that is operative to perform an embodiment of a FP4 dot product instruction 905 stored in storage and/or memory 903. The FP4 dot product instruction 905 may be an instruction specifically designed to perform INT5-based FP4 dot product operations as described herein. Alternatively, the FP4 dot product instruction 905 may not specify an execution mode, but may be executed via INT5-based FP4 dot-product circuitry 935 using the techniques described herein. In either case, the FP4 dot product instruction 905 may represent a macroinstruction, machine code instruction, or other instruction of an instruction set of a processor. The FP4 dot product instruction 905 may have various formats or encodings, including one or more fields for an opcode that at least partially or fully specifies the operation to be performed (e.g., an FP4 dot product) and one or more fields for one or more operands, such as operands usable to identify registers storing source FP4 or INT5 data elements. By way of example, and not limitation, the source data elements may comprise FP4 or INT5 data elements of two matrices to be processed via a set of dot product operations as described herein.

Decoder circuitry 910 (e.g., an instruction decoder) may be coupled to receive and decode each FP4 dot product instruction 905 fetched from memory 903 by instruction fetch circuitry (not shown) into one or more lower-level control signals, operations, or decoded instructions (e.g., one or more micro-instructions, micro-operations, micro-code entry points, etc.).

In some examples, register renaming, allocation, and/or scheduling circuitry 920 may provide functionality for one or more of: (1) renaming logical operand values to physical operand values (e.g., a register alias table in some examples); (2) allocating status bits and flags to the decoded instruction; and (3) scheduling the decoded instruction for execution by execution circuitry out of an instruction pool (e.g., using a reservation station in some examples). Vector registers 950 (and/or memory 903) may store source data elements, intermediate data elements, and result data elements of the FP4 dot product instruction 905.

The execution circuitry 930 may be coupled with the decoder circuitry 910, register rename/allocate/scheduler circuitry 920, and the registers/memory 950 and may perform the dot product operations corresponding to the FP4 dot product instruction 905 as described herein. For example, the one or more lower-level control signals, operations, or decoded instructions may be executed by the execution circuitry to control the execution circuitry to perform operations corresponding to the instruction (e.g., operations that are at least partially specified by the opcode of the instruction). Writeback/retire circuitry 940 performs conflict checks prior to retiring results produced by the execution circuitry 930.

In the illustrated implementation, the execution circuitry 930 includes INT5-based FP4 dot product circuitry 935 for converting FP4 values to INT5 data elements and performing dot product operations as described herein (see, e.g., FIG. 6 and associated text). In some implementations, the execution circuitry 930 includes INT8-based FP4 dot product circuitry (in place of or in addition to the INT5-based FP4 dot product circuitry) for converting FP4 values to INT8 values and performing dot product operations as described with respect to FIG. 8. In these embodiments, the operations may include converting from FP4 to INT5 or INT8, generating sets of partial products, and adding the partial products and constant values to generate dot product results as described herein.

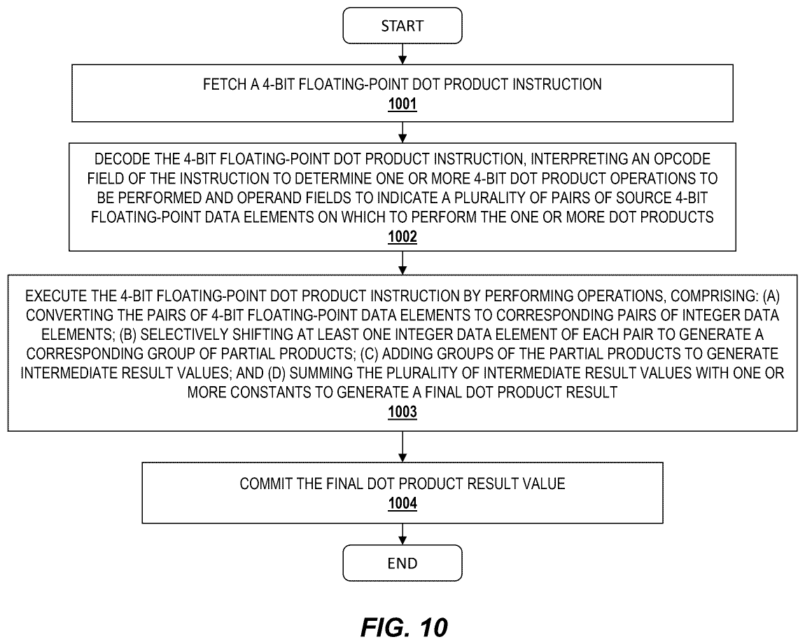

A method in accordance with some implementations is illustrated in FIG. 10. The method may be performed on the various processor, core, and system architectures described herein, but is not necessarily limited to any particular architecture(s).

At 1001, a 4-bit floating-point dot product instruction is fetched from memory or an instruction cache of a processor.

At 1002, the 4-bit floating-point dot product instruction is decoded. The instruction opcode indicates one or more 4-bit floating-point dot product operations to be performed and one or more instruction fields indicate a plurality of pairs of source 4-bit floating-point data elements on which to perform the one or more dot product operations. As mentioned, in some implementations, the pairs of source 4-bit floating-point data elements are pairs of FP4 block floating-point values (e.g., in the E2M1 format).

At 1003, the 4-bit floating-point dot product instruction is executed by performing operations, comprising: (A) converting the pairs of 4-bit floating-point data elements to corresponding pairs of integer data elements; (B) selectively shifting at least one integer data element of each pair to generate a corresponding one or more partial products; (C) adding groups of the partial products to generate intermediate result values; and (D) summing the plurality of intermediate result values with one or more constants to generate a final dot product result. In some implementations described herein, the 4-bit floating-point data elements are converted to INT5 or INT8 data elements, on which the remaining operations are performed.

At 1004, the final dot product result value is committed to the current architectural state (e.g., thereby becoming architecturally visible).

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Processor components disclosed herein may be said and/or claimed to be operative, operable, capable, able, configured adapted, or otherwise to perform an operation. For example, a decoder may be said and/or claimed to decode an instruction, an execution unit may be said and/or claimed to store a result, or the like. As used herein, these expressions refer to the characteristics, properties, or attributes of the components when in a powered-off state, and do not imply that the components or the device or apparatus in which they are included is currently powered on or operating. For clarity, it is to be understood that the processors and apparatus claimed herein are not claimed as being powered on or running.

In the description and claims, the terms “coupled” and/or “connected,” along with their derivatives, may have been used. These terms are not intended as synonyms for each other. Rather, in embodiments, “connected” may be used to indicate that two or more elements are in direct physical and/or electrical contact with each other. “Coupled” may mean that two or more elements are in direct physical and/or electrical contact with each other. However, “coupled” may also mean that two or more elements are not in direct contact with each other, but still co-operate or interact with each other. For example, an execution unit may be coupled with a register and/or a decode unit through one or more intervening components. In the figures, arrows are used to show connections and couplings.

Some embodiments include an article of manufacture (e.g., a computer program product) that includes a machine-readable medium. The medium may include a mechanism that provides, for example stores, information in a form that is readable by the machine. The machine-readable medium may provide, or have stored thereon, an instruction or sequence of instructions, that if and/or when executed by a machine are operative to cause the machine to perform and/or result in the machine performing one or operations, methods, or techniques disclosed herein.

In some embodiments, the machine-readable medium may include a tangible and/or non-transitory machine-readable storage medium. For example, the non-transitory machine-readable storage medium may include a floppy diskette, an optical storage medium, an optical disk, an optical data storage device, a CD-ROM, a magnetic disk, a magneto-optical disk, a read only memory (ROM), a programmable ROM (PROM), an erasable-and-programmable ROM (EPROM), an electrically-erasable-and-programmable ROM (EEPROM), a random access memory (RAM), a static-RAM (SRAM), a dynamic-RAM (DRAM), a Flash memory, a phase-change memory, a phase-change data storage material, a non-volatile memory, a non-volatile data storage device, a non-transitory memory, a non-transitory data storage device, or the like. The non-transitory machine-readable storage medium does not consist of a transitory propagated signal. In some embodiments, the storage medium may include a tangible medium that includes solid-state matter or material, such as, for example, a semiconductor material, a phase change material, a magnetic solid material, a solid data storage material, etc. Alternatively, a non-tangible transitory computer-readable transmission media, such as, for example, an electrical, optical, acoustical, or other form of propagated signals—such as carrier waves, infrared signals, and digital signals, may optionally be used.

Examples of suitable machines include, but are not limited to, a general-purpose processor, a special-purpose processor, a digital logic circuit, an integrated circuit, or the like. Still other examples of suitable machines include a computer system or other electronic device that includes a processor, a digital logic circuit, or an integrated circuit. Examples of such computer systems or electronic devices include, but are not limited to, desktop computers, laptop computers, notebook computers, tablet computers, netbooks, smartphones, cellular phones, servers, network devices (e.g., routers and switches.), Mobile Internet devices (MIDs), media players, smart televisions, nettops, set-top boxes, and video game controllers.

Moreover, in the various examples described above, unless specifically noted otherwise, disjunctive language such as the phrase “at least one of A, B, or C” or “A, B, and/or C” is intended to be understood to mean either A, B, or C, or any combination thereof (i.e. A and B, A and C, B and C, and A, B and C).

In the description above, specific details have been set forth to provide a thorough understanding of the embodiments. However, other embodiments may be practiced without some of these specific details. Various modifications and changes may be made thereunto without departing from the broader spirit and scope of the disclosure as set forth in the claims. The specification and drawings are, accordingly, to be regarded in an illustrative rather than a restrictive sense. The scope of the invention is not to be determined by the specific examples provided above, but only by the claims below. In other instances, well-known circuits, structures, devices, and operations have been shown in block diagram form and/or without detail to avoid obscuring the understanding of the description.

### EXAMPLES

The following are example implementations of different embodiments of the invention.

Example 1. A processor, comprising: one or more vector registers to store a plurality of source 4-bit floating-point data elements; decode circuitry to decode a 4-bit floating-point dot product instruction, the instruction having an opcode to indicate one or more 4-bit floating-point dot product operations to be performed and one or more fields indicate a plurality of pairs of the source 4-bit floating-point data elements on which to perform the one or more dot product operations; and execution circuitry to execute the 4-bit floating-point dot product instruction, the execution circuitry to convert the plurality of pairs of 4-bit floating-point data elements to a corresponding plurality of pairs of integer data elements; to selectively shift at least one integer data element of each pair to generate a corresponding one or more partial products; to add groups of partial products to generate a plurality of intermediate result values; and to add the plurality of intermediate result values to generate a final dot product result.

Example 2. The processor of example 1, wherein the plurality of pairs of integer data elements comprise signed 5-bit integer (INT5) or signed 8-bit integer (INT8) data elements.

Example 3. The processor of examples 1 or 2, wherein each pair of integer data elements of the plurality of pairs comprises a multiplicand and a corresponding multiplier, the execution circuitry comprising shift circuitry to shift each multiplicand in accordance with one or more bit values of the corresponding multiplier to generate the corresponding group of partial products.

Example 4. The processor of any of examples 1-3, wherein the multiplicand comprises a 4-bit always-positive integer and the multiplier comprises a 5-bit integer.

Example 5. The processor of any of examples 1-4, wherein the execution circuitry includes sign processing circuitry to configure the 4-bit always-positive integer to always have a positive value.

Example 6. The processor of any of examples 1-5, wherein in response to detecting a negative input multiplicand, the sign processing circuitry is to responsively toggle a first sign bit of the input multiplicand and a second sign bit of a corresponding input multiplier.

Example 7. The processor of any of examples 1-6, wherein the execution circuitry is to add the plurality of intermediate result values and one or more constants to generate the final dot product result.

Example 8. A method, comprising: storing, in one or more vector registers, a plurality of source 4-bit floating-point data elements; decoding, by decode circuitry, a 4-bit floating-point dot product instruction, the instruction having an opcode to indicate one or more 4-bit floating-point dot product operations to be performed and one or more fields indicate a plurality of pairs of the source 4-bit floating-point data elements on which to perform the one or more dot product operations; and executing, by execution circuitry, the 4-bit floating-point dot product instruction, wherein executing comprises: converting the plurality of pairs of 4-bit floating-point data elements to a corresponding plurality of pairs of integer data elements; selectively shifting at least one integer data element of each pair to generate a corresponding one or more partial products; adding groups of partial products to generate a plurality of intermediate result values; and summing the plurality of intermediate result values to generate a final dot product result.

Example 9. The method of example 8, wherein the plurality of pairs of integer data elements comprise signed 5-bit integer (INT5) or signed 8-bit integer (INT8) data elements.

Example 10. The method of examples 8 or 9, wherein each pair of integer data elements of the plurality of pairs comprises a multiplicand and a corresponding multiplier, the execution circuitry comprising shift circuitry to shift each multiplicand in accordance with one or more bit values of the corresponding multiplier to generate the corresponding group of partial products.

Example 11. The method of any of examples 8-10, wherein the multiplicand comprises a 4-bit always-positive integer and the multiplier comprises a 5-bit integer.

Example 12. The method of any of examples 8-11, further comprising: configuring the 4-bit always-positive integer by sign processing circuitry to always have a positive value.

Example 13. The method of any of examples 8-12, wherein in response to detecting a negative input multiplicand, responsively toggling a first sign bit of the input multiplicand and a second sign bit of a corresponding input multiplier.

Example 14. The method of any of examples 8-13, wherein the plurality of intermediate result values are summed with one or more constants to generate the final dot product result.

Example 15. A machine-readable medium having program code stored thereon which, when executed by a machine, causes the machine to perform operations, comprising: storing, in one or more vector registers, a plurality of source 4-bit floating-point data elements; decoding, by decode circuitry, a 4-bit floating-point dot product instruction, the instruction having an opcode to indicate one or more 4-bit floating-point dot product operations to be performed and one or more fields indicate a plurality of pairs of the source 4-bit floating-point data elements on which to perform the one or more dot product operations; and executing, by execution circuitry, the 4-bit floating-point dot product instruction, wherein executing comprises: converting the plurality of pairs of 4-bit floating-point data elements to a corresponding plurality of pairs of integer data elements; selectively shifting at least one integer data element of each pair to generate a corresponding one or more partial products; adding groups of partial products to generate a plurality of intermediate result values; and adding the plurality of intermediate result values to generate a final dot product result.

Example 16. The machine-readable medium of example 15, wherein the plurality of pairs of integer data elements comprise signed 5-bit integer (INT5) or signed 8-bit integer (INT8) data elements.

Example 17. The machine-readable medium of examples 15 or 16, wherein each pair of integer data elements of the plurality of pairs comprises a multiplicand and a corresponding multiplier, the execution circuitry comprising shift circuitry to shift each multiplicand in accordance with one or more bit values of the corresponding multiplier to generate the corresponding group of partial products.

Example 18. The machine-readable medium of any of examples 15-17, wherein the multiplicand comprises a 4-bit always-positive integer and the multiplier comprises a 5-bit integer.

Example 19. The machine-readable medium of any of examples 15-18, further comprising program code to cause the machine to perform the operation of: configuring the 4-bit always-positive integer by sign processing circuitry to always have a positive value.

Example 20. The machine-readable medium of any of examples 15-19, wherein in response to detecting a negative input multiplicand, responsively toggling a first sign bit of the input multiplicand and a second sign bit of a corresponding input multiplier.

Embodiments of the invention may include various steps, which have been described above. The steps may be embodied in machine-executable instructions which may be used to cause a general-purpose or special-purpose processor to perform the steps. Alternatively, these steps may be performed by specific hardware components that contain hardwired logic for performing the steps, or by any combination of programmed computer components and custom hardware components.

As described herein, instructions may refer to specific configurations of hardware such as application specific integrated circuits (ASICs) configured to perform certain operations or having a predetermined functionality or software instructions stored in memory embodied in a non-transitory computer readable medium. Thus, the techniques shown in the Figures can be implemented using code and data stored and executed on one or more electronic devices (e.g., an end station, a network element, etc.). Such electronic devices store and communicate (internally and/or with other electronic devices over a network) code and data using computer machine-readable media, such as non-transitory computer machine-readable storage media (e.g., magnetic disks; optical disks; random access memory; read only memory; flash memory devices; phase-change memory) and transitory computer machine-readable communication media (e.g., electrical, optical, acoustical or other form of propagated signals—such as carrier waves, infrared signals, digital signals, etc.). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). The storage device and signals carrying the network traffic respectively represent one or more machine-readable storage media and machine-readable communication media. Thus, the storage device of a given electronic device typically stores code and/or data for execution on the set of one or more processors of that electronic device. Of course, one or more parts of an embodiment of the invention may be implemented using different combinations of software, firmware, and/or hardware. Throughout this detailed description, for the purposes of explanation, numerous specific details were set forth in order to provide a thorough understanding of the present invention. It will be apparent, however, to one skilled in the art that the invention may be practiced without some of these specific details. In certain instances, well known structures and functions were not described in elaborate detail in order to avoid obscuring the subject matter of the present invention. Accordingly, the scope and spirit of the invention should be judged in terms of the claims which follow.

What is claimed is:

1. A processor, comprising:
one or more registers to store a plurality of source 4-bit floating-point data elements;
decode circuitry to decode a 4-bit floating-point dot product instruction, the instruction having an opcode to indicate one or more 4-bit floating-point dot product operations to be performed and one or more fields indicate a plurality of pairs of the source 4-bit floating-point data elements on which to perform the one or more dot product operations; and
execution circuitry to execute the 4-bit floating-point dot product instruction, the execution circuitry:
to convert the plurality of pairs of 4-bit floating-point data elements to a corresponding plurality of pairs of integer data elements;
to selectively shift at least one integer data element of each pair to generate a corresponding one or more partial products;
to add groups of partial products to generate a plurality of intermediate result values; and
to add the plurality of intermediate result values to generate a final dot product result.

2. The processor of claim 1, wherein the plurality of pairs of integer data elements comprise signed 5-bit integer (INT5) or signed 8-bit integer (INT8) data elements.

3. The processor of claim 1, wherein each pair of integer data elements of the plurality of pairs comprises a multiplicand and a corresponding multiplier, the execution circuitry comprising shift circuitry to shift each multiplicand in accordance with one or more bit values of the corresponding multiplier to generate the corresponding group of partial products.

4. The processor of claim 3, wherein the multiplicand comprises a 4-bit always-positive integer and the multiplier comprises a 5-bit integer.

5. The processor of claim 4, wherein the execution circuitry includes sign processing circuitry to configure the 4-bit always-positive integer to always have a positive value.

6. The processor of claim 5, wherein in response to detecting a negative input multiplicand, the sign processing circuitry is to responsively toggle a sign bit of one or both of the input multiplicand and a corresponding input multiplier.

7. The processor of claim 1, wherein the execution circuitry is to add the plurality of intermediate result values and one or more constants to generate the final dot product result.

8. A method, comprising:
storing, in one or more registers, a plurality of source 4-bit floating-point data elements;
decoding, by decode circuitry, a 4-bit floating-point dot product instruction, the instruction having an opcode to indicate one or more 4-bit floating-point dot product operations to be performed and one or more fields indicate a plurality of pairs of the source 4-bit floating-point data elements on which to perform the one or more dot product operations; and
executing, by execution circuitry, the 4-bit floating-point dot product instruction, wherein executing comprises: converting the plurality of pairs of 4-bit floating-point data elements to a corresponding plurality of pairs of integer data elements; selectively shifting at least one integer data element of each pair to generate a corresponding one or more partial products; adding groups of partial products to generate a plurality of intermediate result values; and summing the plurality of intermediate result values to generate a final dot product result.

9. The method of claim 8, wherein the plurality of pairs of integer data elements comprise signed 5-bit integer (INT5) or signed 8-bit integer (INT8) data elements.

10. The method of claim 8, wherein each pair of integer data elements of the plurality of pairs comprises a multiplicand and a corresponding multiplier, the execution circuitry comprising shift circuitry to shift each multiplicand in accordance with one or more bit values of the corresponding multiplier to generate the corresponding group of partial products.

11. The method of claim 10, wherein the multiplicand comprises a 4-bit always-positive integer and the multiplier comprises a 5-bit integer.

12. The method of claim 11, further comprising: configuring the 4-bit always-positive integer by sign processing circuitry to always have a positive value.

13. The method of claim 12, wherein in response to detecting a negative input multiplicand, the sign processing circuitry is to responsively toggle a sign bit of one or both of the input multiplicand and a corresponding input multiplier.

14. The method of claim 8, wherein the plurality of intermediate result values are summed with one or more constants to generate the final dot product result.

15. A machine-readable medium having program code stored thereon which, when executed by a machine, causes the machine to perform operations, comprising:
storing, in one or more registers, a plurality of source 4-bit floating-point data elements;
decoding, by decode circuitry, a 4-bit floating-point dot product instruction, the instruction having an opcode to indicate one or more 4-bit floating-point dot product operations to be performed and one or more fields indicate a plurality of pairs of the source 4-bit floating-point data elements on which to perform the one or more dot product operations; and
executing, by execution circuitry, the 4-bit floating-point dot product instruction, wherein executing comprises: converting the plurality of pairs of 4-bit floating-point data elements to a corresponding plurality of pairs of integer data elements; selectively shifting at least one integer data element of each pair to generate a corresponding one or more partial products; adding groups of partial products to generate a plurality of intermediate result values; and adding the plurality of intermediate result values to generate a final dot product result.

16. The machine-readable medium of claim 15, wherein the plurality of pairs of integer data elements comprise signed 5-bit integer (INT5) or signed 8-bit integer (INT8) data elements.

17. The machine-readable medium of claim 15, wherein each pair of integer data elements of the plurality of pairs comprises a multiplicand and a corresponding multiplier, the execution circuitry comprising shift circuitry to shift each multiplicand in accordance with one or more bit values of the corresponding multiplier to generate the corresponding group of partial products.

18. The machine-readable medium of claim 17, wherein the multiplicand comprises a 4-bit always-positive integer and the multiplier comprises a 5-bit integer.

19. The machine-readable medium of claim 18, further comprising program code to cause the machine to perform the operation of: configuring the 4-bit always-positive integer by sign processing circuitry to always have a positive value.

20. The machine-readable medium of claim 19, wherein in response to detecting a negative input multiplicand, responsively toggling a first sign bit of the input multiplicand and a second sign bit of a corresponding input multiplier.
